(19) United States
(12) Patent Application Publication
(10) Pub. No.: US 2010/0182406 A1
(43) Pub. Date: Jul. 22, 2010

(54) SYSTEM AND METHOD FOR THREE-DIMENSIONAL OBJECT RECONSTRUCTION FROM TWO-DIMENSIONAL IMAGES

(76) Inventor: Ana B. Benitez, Brooklyn, NY (US)

Correspondence Address: Robert D. Shedd, Patent Operations;THOMSON Licensing LLC, P.O. Box 5312, Princeton, NJ, 08543-5312, US

(21) Appl. No.: 12/668,718

(22) PCT Filed: Jul. 12, 2007
(86) PCT No.: PCT/US07/15891

§ 371 Date: Jan. 12, 2010

(51) Int. Cl. H04N 13/02

(52) U.S. Cl. 348/46; 348/E13.074

(57) ABSTRACT

A system and method for three-dimensional acquisition and modeling of a scene using two-dimensional images are provided. The present disclosure provides a system and method for selecting and combining the three-dimensional acquisition techniques that best fit the capture environment and conditions under consideration, and hence produce more accurate three-dimensional models. The system and method provide for acquiring at least two two-dimensional images of a scene, applying a first depth acquisition function to the at least two two-dimensional images, applying a second depth acquisition function to the at least two two-dimensional images, combining an output of the first depth acquisition function with an output of the second depth acquisition function, and generating a disparity or depth map from the combined output. The system and method also provide for reconstructing a three-dimensional model of the scene from the generated disparity or depth map.

### TECHNICAL FIELD OF THE INVENTION

The present disclosure generally relates to three-dimensional object modeling, and more particularly, to a system and method for three-dimensional (3D) information acquisition from two-dimensional (2D) images that combines multiple 3D acquisition functions for the accurate recovery of 3D information of real world scenes.

### BACKGROUND OF THE INVENTION

When a scene is filmed, the resulting video sequence contains implicit information on the three-dimensional (3D) geometry of the scene. While for adequate human perception this implicit information suffices, for many applications the exact geometry of the 3D scene is required. One category of these applications is when sophisticated data processing techniques are used, for instance in the generation of new views of the scene, or in the reconstruction of the 3D geometry for industrial inspection applications.

The process of generating 3D models from single or multiple images is important for many film post-production applications. Recovering 3D information has been an active research area for some time. There are a large number of techniques in the literature that either captures 3D information directly, for example, using a laser range finder, or recovers 3D information from one or multiple two-dimensional (2D) images such as stereo or structure from motion techniques. 3D acquisition techniques in general can be classified as active and passive approaches, single view and multi-view approaches, and geometric and photometric methods.

Passive approaches acquire 3D geometry from images or videos taken under regular lighting conditions. 3D geometry is computed using the geometric or photometric features extracted from images and videos. Active approaches use special light sources, such as laser, structured light or infrared light. Active approaches compute the geometry based on the response of the objects and scenes to the special light projected onto the surface of the objects and scenes.

Single-view approaches recover 3D geometry using multiple images taken from a single camera viewpoint. Examples include structure from motion and depth from defocus.

Multi-view approaches recover 3D geometry from multiple images taken from multiple camera viewpoints, resulted from object motion, or with different light source positions. Stereo matching is an example of multi-view 3D recovery by matching the pixels in the left image and right image in the stereo pair to obtain the depth information of the pixels.

Geometric methods recover 3D geometry by detecting geometric features such as corners, edges, lines or contours in single or multiple images. The spatial relationship among the extracted corners, edges, lines or contours can be used to infer the 3D coordinates of the pixels in images. Structure From Motion (SFM) is a technique that attempts to reconstruct the 3D structure of a scene from a sequence of images taken from a camera moving within the scene or a static camera and a moving object. Although many agree that SFM is fundamentally a nonlinear problem, several attempts at representing it linearly have been made that provide mathematical elegance as well as direct solution methods. On the other hand, nonlinear techniques require iterative optimization, and must contend with local minima. However, these techniques promise good numerical accuracy and flexibility. The advantage of SFM over the stereo matching is that one camera is needed. Feature based approaches can be made more effective by tracking techniques, which exploits the past history of the features' motion to predict disparities in the next frame. Second, due to small spatial and temporal differences between 2 consecutive frames, the correspondence problem can be also cast as a problem of estimating the apparent motion of the image brightness pattern, called the optical flow. There are several algorithms that use SFM; most of them are based on the reconstruction of 3D geometry from 2D images. Some assume known correspondence values, and others use statistical approaches to reconstruct without correspondence.

Photometric methods recover 3D geometry based on the shading or shadow of the image patches resulting from the orientation of the scene surface.

The above-described methods have been extensively studied for decades. However, no single technique performs well in all situations and most of the past methods focus on 3D reconstruction under laboratory conditions, which make the reconstruction relatively easy. For real-world scenes, subjects could be in movement, lighting may be complicated, and depth range could be large. It is difficult for the above-identified techniques to handle these real-world conditions. For instance, if there is a large depth discontinuity between the foreground and background objects, the search range of stereo matching has to be significantly increased, which could result in unacceptable computational costs, and additional depth estimation errors.

### SUMMARY

A system and method for three-dimensional (3D) acquisition and modeling of a scene using two-dimensional (2D) images are provided. The present disclosure provides a system and method for selecting and combining the 3D acquisition techniques that best fit the capture environment and conditions under consideration, and hence produce more accurate 3D models. The techniques used depend on the scene under consideration. For example, in outdoor scenes stereo passive techniques would be used in combination with structure from motion. In other cases, active techniques may be more appropriate. Combining multiple 3D acquisition functions result in higher accuracy than if only one technique or function was used. The results of the multiple 3D acquisition functions will be combined to obtain a disparity or depth map which can be used to generate a complete 3D model. The target application of this work is 3D reconstruction of film sets. The resulting 3D models can be used for visualization during the film shooting or for postproduction.

Other applications will benefit from this approach including but not limited to gaming and 3D TV that employs a 2D+depth format.

According to one aspect of the present disclosure, a three-dimensional (3D) acquisition method is provided. The method includes acquiring at least two two-dimensional (2D) images of a scene; applying a first depth acquisition function to the at least two 2D images; applying a second depth acquisition function to the at least two 2D images; combining an output of the first depth acquisition function with an output of the second depth acquisition function; and generating a disparity map from the combined output of the first and second depth acquisition functions.

In another aspect, the method further includes generating a depth map from the disparity map.

In a further aspect, the method includes reconstructing a three-dimensional model of the scene from the generated disparity or depth map.

According to another aspect of the present disclosure, a system for three-dimensional (3D) information acquisition from two-dimensional (2D) images includes means for acquiring at least two two-dimensional (2D) images of a scene; and a 3D acquisition module configured for applying a first depth acquisition function to the at least two 2D images, applying a second depth acquisition function to the at least two 2D images and combining an output of the first depth acquisition function with an output of the second depth acquisition function. The 3D acquisition module is further configured for generating a disparity map from the combined output of first and second depth acquisition functions.

According to a further aspect of the present disclosure, a program storage device readable by a machine, tangibly embodying a program of instructions executable by the machine to perform method steps for acquiring three-dimensional (3D) information from two-dimensional (2D) images is provided, the method including acquiring at least two two-dimensional (2D) images of a scene; applying a first depth acquisition function to the at least two 2D images; applying a second depth acquisition function to the at least two 2D images; combining an output of the first depth acquisition function with an output of the second depth acquisition function; and generating a disparity map from the combined output of the first and second depth acquisition functions.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is an illustration of an exemplary system for three-dimensional (3D) depth information acquisition according to an aspect of the present disclosure;

FIG. 2 is a flow diagram of an exemplary method for reconstructing three-dimensional (3D) objects or scenes from two-dimensional (2D) images according to an aspect of the present disclosure;

FIG. 3 is a flow diagram of an exemplary two-pass method for 3D depth information acquisition according to an aspect of the present disclosure;

FIG. 4A illustrates two input stereo images and FIG. 4B illustrates two input structured light images;

FIG. 5A is a disparity map generated from the stereo images shown in FIG. 4B;

FIG. 5B is a disparity map generated from the structured light images shown in FIG. 4A;

FIG. 5C is a disparity map resulting from the combination of the disparity maps shown in FIGS. 5A and 5B using a simple average combination method; and

FIG. 5D is a disparity map resulting from the combination of the disparity maps shown in FIGS. 5A and 5B using a weighted average combination method.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The techniques disclosed in the present disclosure deal with the problem of recovering 3D geometries of objects and scenes. Recovering the geometry of real-world scenes is a challenging problem due to the movement of subjects, large depth discontinuity between foreground and background, and complicated lighting conditions. Fully recovering the complete geometry of a scene using one technique is computationally expensive and unreliable. Some of the techniques for accurate 3D acquisition, such as laser scan, are unacceptable in many situations due to the presence of human subjects. The present disclosure provides a system and method for selecting and combining the 3D acquisition techniques that best fit the capture environment and conditions under consideration, and hence produce more accurate 3D models.

A system and method for combining multiple 3D acquisition methods for the accurate recovery of 3D information of real world scenes are provided. Combining multiple methods is motivated by the lack of a single method capable of capturing 3D information for real and large environments reliably. Some methods work well indoors but not outdoors, others require a static scene. Also computation complexity/accuracy varies substantially between various methods. The system and method of present disclosure defines a framework for capturing 3D information that takes advantage of the strengths of available techniques to obtain the best 3D information. The system and method of the present disclosure provides for acquiring at least two two-dimensional (2D) images of a scene; applying a first depth acquisition function to the at least two 2D images; applying a second depth acquisition function to the at least two 2D images; combining an output of the first depth acquisition function with an output of the second depth acquisition function; and generating a disparity map from the combined output of the first and second depth acquisition functions. Since disparity information is inversely proportional to depth multiplied by a scaling factor, a disparity map or a depth map generated from the combined output may be used to reconstruct 3D objects or scene.

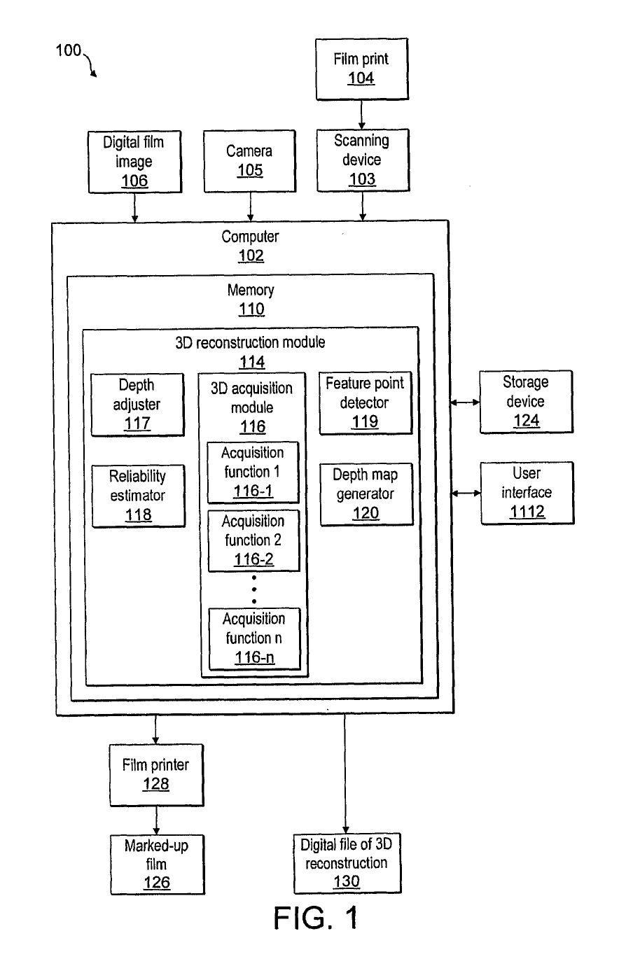

Referring now to the Figures, exemplary system components according to an embodiment of the present disclosure are shown in FIG. 1. A scanning device 103 may be provided for scanning film prints 104, e.g., camera-original film negatives, into a digital format, e.g. Cineon-format or Society of Motion Picture and Television Engineers (SMPTE) Digital Picture Exchange (DPX) files. The scanning device 103 may comprise, e.g., a telecine or any device that will generate a video output from film such as, e.g., an Arri LocPro™ with video output. Digital images or a digital video file may be acquired by capturing a temporal sequence of video images with a digital video camera 105. Alternatively, files from the post production process or digital cinema 106 (e.g., files already in computer-readable form) can be used directly. Potential sources of computer-readable files are AVID™ editors, DPX files, D5 tapes etc.

Scanned film prints are input to a post-processing device 102, e.g., a computer. The computer is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as post-processing device 102. In addition, various other peripheral devices may be connected to the computer platform by various interfaces and bus structures, such a parallel port, serial port or universal serial bus (USB). Other peripheral devices may include additional storage devices 124 and a printer 128. The printer 128 may be employed for printed a revised version of the film 126 wherein scenes may have been altered or replaced using 3D modeled objects as a result of the techniques described below.

Alternatively, files/film prints already in computer-readable form 106 (e.g., digital cinema, which for example, may be stored on external hard drive 124) may be directly input into the computer 102. Note that the term “film” used herein may refer to either film prints or digital cinema.

A software program includes a three-dimensional (3D) reconstruction module 114 stored in the memory 110. The 3D reconstruction module 114 includes a 3D acquisition module 116 for acquiring 3D information from images. The 3D acquisition module 116 includes several 3D acquisition functions 116-1 . . . 116-n such as, but not limited to, a stereo matching function, a structured light function, structure from motion function, and the like.

A depth adjuster 117 is provided for adjusting the depth scales of the disparity or depth map generated from the different acquisition methods. The depth adjuster 117 scales the depth value of the pixels in the disparity or depth maps to 0-255 for each method.

A reliability estimator 118 is provided and configured for estimating the reliability of depth values for the image pixels. The reliability estimator 118 compares the depth values of each method. If the values from the various functions or methods are close or within a predetermined range, the depth value is considered reliable; otherwise, the depth value is not reliable.

The 3D reconstruction module 114 also includes a feature point detector 119 for detecting feature points in an image. The feature point detector 119 will include at least one feature point detection function, e.g., algorithms, for detecting or selecting feature points to be employed to register disparity maps. A depth map generator 120 is also provided for generating a depth map from the combined depth information.

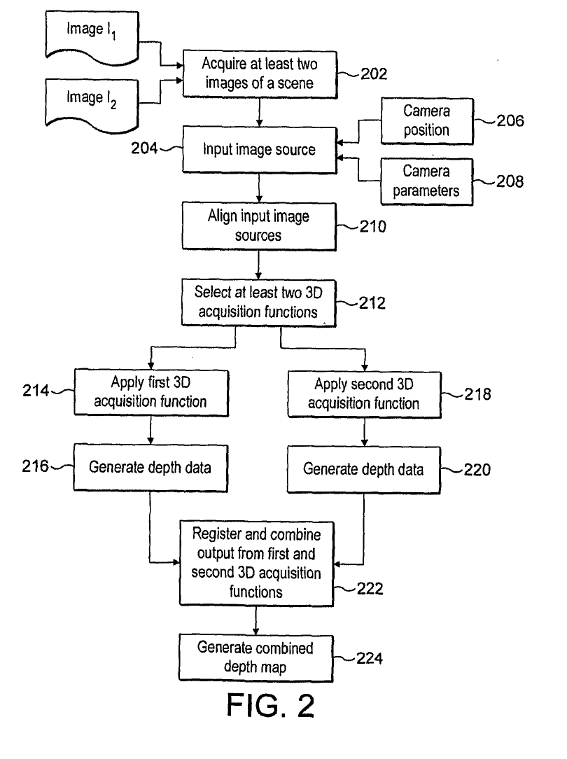

FIG. 2 is a flow diagram of an exemplary method for reconstructing three-dimensional (3D) objects from two-dimensional (2D) images according to an aspect of the present disclosure.

Referring to FIG. 2, initially, in step 202, the post-processing device 102 obtains the digital master video file in a computer-readable format. The digital video file may be acquired by capturing a temporal sequence of video images with a digital video camera 105. Alternatively, a conventional film-type camera may capture the video sequence. In this scenario, the film is scanned via scanning device 103 and the process proceeds to step 204. The camera will acquire 2D images while moving either the object in a scene or the camera. The camera will acquire multiple viewpoints of the scene.

It is to be appreciated that whether the film is scanned or already in digital format, the digital file of the film will include indications or information on locations of the frames (i.e. timecode), e.g., a frame number, time from start of the film, etc. Each frame of the digital video file will include one image, e.g., I₁, I₂, . . . Iₙ.

Combining multiple methods creates the need for new techniques to register the output of each method in a common coordinate system. The registration process can complicate the combination process significantly. In the method of the present disclosure, input image source information can be collected, at step 204, at the same time for each method. This simplifies registration since camera position at step 206 and camera parameters at step 208 are the same for all techniques. However, the input image source can be different for each 3D capture methods used. For example, if stereo matching is used the input image source should be two cameras separated by an appropriate distance. In another example, if structured light is used the input image source is one or more images of structured light illuminated scenes. Preferably, the input image source to each function is aligned so that the registration of the functions' outputs is simple and straightforward. Otherwise manual or automatic registration techniques are implemented to align, at step 210, the input image sources.

In step 212, an operator via user interface 112 selects at least two 3D acquisitions functions. The 3D acquisition functions used depend on the scene under consideration. For example, in outdoor scenes stereo passive techniques would be used in combination with structure from motion. In other cases, active techniques may be more appropriate. In another example, a structured light function may be combined with a laser range finder function for a static scene. In a third example, more than two cameras can be used in an indoor scene by combining a shape from silhouette function and a stereo matching function.

A first 3D acquisition function is applied to the images in step 214 and first depth data is generated for the images in step 216. A second 3D acquisition function is applied to the images in step 218 and second depth data is generated for the images in step 220. It is to be appreciated that steps 214 and 216 may be performed concurrently or simultaneously with steps 218 and 220. Alternatively, each 3D acquisition function may be performed separately, stored in memory and retrieved at a later time for the combining step as will be described below.

In step 222, the output of each 3D depth acquisition function is registered and combined. If the image sources are properly aligned, no registration is needed and the depth values can be combined efficiently. If the image sources are not aligned, the resulting disparity maps need to be aligned properly. This can be done manually or by matching a feature (e.g. marker, corner, edge) from one image to the other image via the feature point detector 119 and then shifting one of the disparity maps accordingly. Feature points are the salient features of an image, such as corners, edges, lines or the like, where there is a high amount of image intensity contrast. The feature point detector 119 may use a Kitchen-Rosenfeld corner detection operator C, as is well known in the art. This operator is used to evaluate the degree of “cornerness” of the image at a given pixel location. “Corners” are generally image features characterized by the intersection of two directions of image intensity gradient maxima, for example at a 90 degree angle. To extract feature points, the Kitchen-Rosenfeld operator is applied at each valid pixel position of image I₁. The higher the value of the operator C at a particular pixel, the higher its degree of “cornerness”, and the pixel position (x,y) in image I₁ is a feature point if C at (x,y) is greater than at other pixel positions in a neighborhood around (x,y). The neighborhood may be a 5×5 matrix centered on the pixel position (x,y). To assure robustness, the selected feature points may have a degree of cornerness greater than a threshold, such as T_{c}=10. The output from the feature point detector 118 is a set of feature points {F₁} in image I₁ where each F₁ corresponds to a “feature” pixel position in image I₁. Many other feature point detectors can be employed including but not limited to Scale-Invariant Feature Transform (SIFT), Smallest Univalue Segment Assimilating Nucleus (SUSAN), Hough transform, Sobel edge operator and Canny edge detector: After the detected feature points are chosen, a second image I₂ is processed by the feature point detector 119 to detect the features found in the first image I₁ and match the features to align the images.

One of the remaining registration issues is to adjust the depth scales of the disparity map generated from the different 3D acquisition methods. This could be done automatically since a constant multiplicative factor can be fitted to the depth data available for the same pixels or points in the scene. For example, the minimum value output from each method can be scaled to 0 and the maximum value output from each method can be scaled to 255.

Combining the results of the various 3D depth acquisition functions depend on many factors. Some functions or algorithms, for example, produce sparse depth data where many pixels have no depth information. Therefore, the function combination relies on other functions. If multiple functions produced depth data at a pixel, the data may be combined by taking the average of estimated depth data. A simple combination method combines the two disparity maps by averaging the disparity values from the two disparity maps for each pixel.

Weights could be assigned to each function based on operator confidence in the function results before combining the results, e.g., based on the capture conditions (e.g., indoors, outdoors, lighting conditions) or based on the local visual features of the pixels. For instance, stereo-based approaches in general are inaccurate for the regions without texture, while structured light based methods could perform very well. Therefore, more weight can be assigned to the structured light based method by detecting the texture features of the local regions. In another example, the structured light method usually performs poorly for dark areas, while the performance of stereo matching remains reasonably good. Therefore, in this example, more weight can be assigned to the stereo matching technique.

The weighted combination method calculates the weighted average of the disparity values from the two disparity maps. The weight is determined by the intensity value of the corresponding pixel in the left-eye image of a corresponding pixel pair between the left eye and right eye images, e.g., a stereoscopic pair. If the intensity value is large, a large weight is assigned to the structured light disparity map; otherwise, a large weight is assigned to the stereo disparity map. Mathematically, the resulting disparity value is

D(x,y)=w(x,y)Dl(x,y)+(1−w(x,y))Ds(x,y),

w(x,y)=g(x,y)/C

where Dl is the disparity map from structured light, Ds is the disparity map from stereo, D is the combined disparity map, g(x,y) is the intensity value of the pixel at (x,y) on the left-eye image and C is a normalization factor to normalize the weights to the range from 0 to 1. For example, for 8 bit color depth, C should be 255.

Using the system and method of the present disclosure, multiple depth estimates are available for the same pixel or point in the scene, one for each 3D acquisition method used. Therefore, the system and method can also estimate the reliability of the depth values for the image pixels. For example, if all the 3D acquisition methods output very similar depth values for one pixel, e.g., within a predetermined range, then, that depth value can be considered as very reliable. The opposite should happen when the depth values obtained by the different 3D acquisition methods differ vastly.

The combined disparity map may then be converted into a depth map at step 224. Disparity is inversely related to depth with a scaling factor related to camera calibration parameters. Camera calibration parameters are obtained and are employed by the depth map generator 122 to generator a depth map for the object or scene between the two images. The camera parameters include but are not limited to the focal length of the camera and the distance between the two camera shots. The camera parameters may be manually entered into the system 100 via user interface 112 or estimated from camera calibration algorithms or functions. Using the camera parameters, the depth map is generated from the combined output of the multiple 3D acquisition functions. A depth map is a two-dimension array of values for mathematically representing a surface in space, where the rows and columns of the array correspond to the x and y location information of the surface; and the array elements are depth or distance readings to the surface from a given point or camera location. A depth map can be viewed as a grey scale image of an object, with the depth information replacing the intensity information, or pixels, at each point on the surface of the object. Accordingly, surface points are also referred to as pixels within the technology of 3D graphical construction, and the two terms will be used interchangeably within this disclosure. Since disparity information is inversely proportional to depth multiplied by a scaling factor, disparity information can be used directly for building the 3D scene model for most applications. This simplifies the computation since it makes computation of camera parameters unnecessary.

A complete 3D model of an object or a scene can be reconstructed from the disparity or depth map. The 3D models can then be used for a number of applications such as postproduction application and creating 3D content from 2D. The resulting combined image can be visualized using conventional visualization tools such as the ScanAlyze software developed at Stanford University of Stanford, Calif.

The reconstructed 3D model of a particular object or scene may then be rendered for viewing on a display device or saved in a digital file 130 separate from the file containing the images. The digital file of 3D reconstruction 130 may be stored in storage device 124 for later retrieval, e.g., during an editing stage of the film where a modeled object may be inserted into a scene where the object was not previously present.

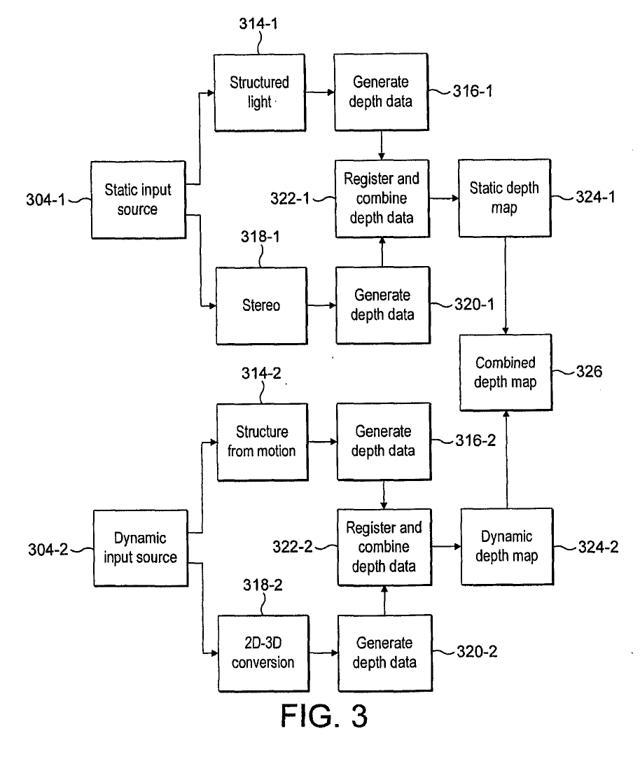

Other conventional systems use a two-pass approach to recover the geometry of the static background and dynamic foreground separately. Once the background geometry is acquired, e.g., a static source, it can be used as a priori information to acquire the 3D geometry of moving subjects, e.g. a dynamic source. This conventional method can reduce computational cost and increases reconstruction accuracy by restricting the computation within Regions-of-Interest. However, it has been observed that the use of single technique for recovering 3D information in each pass is not sufficient. Therefore, in another embodiment, the method of the present disclosure employing multiple depth techniques is used in each pass of a two-pass approach. FIG. 3 illustrates an exemplary method that combines the results from stereo and structured light to recover the geometry of static scenes, e.g., background scenes, and 2D-3D conversion and structure from motion for dynamic scenes, e.g., foreground scenes. The steps shown in FIG. 3 are similar to the steps described in relation to FIG. 2 and therefore, have similar reference numerals where the -1 steps, e.g., 304-1, represents steps in the first pass and -2 steps, e.g., 304-2, represents the steps in the second pass. For example, a static input source is provided in step 304-1. A first 3D acquisition function is performed at step 314-1 and depth data is generated at step 316-1. A second 3D acquisition function is performed at step 318-1, depth data generated at step 320-1 and the depth data from the two 3D acquisition functions is combined in step 322-1 and a static disparity or depth map is generated in step 324-1. Similarly, a dynamic disparity or depth map is generated by steps 304-2 through 322-2. In step 326, a combined disparity or depth map is generated from the static disparity or depth map from the first pass and the dynamic disparity or depth map from the second pass. It is to be appreciated that FIG. 3 is just one possible example, and other algorithms and/or functions may be used and combined, as needed.

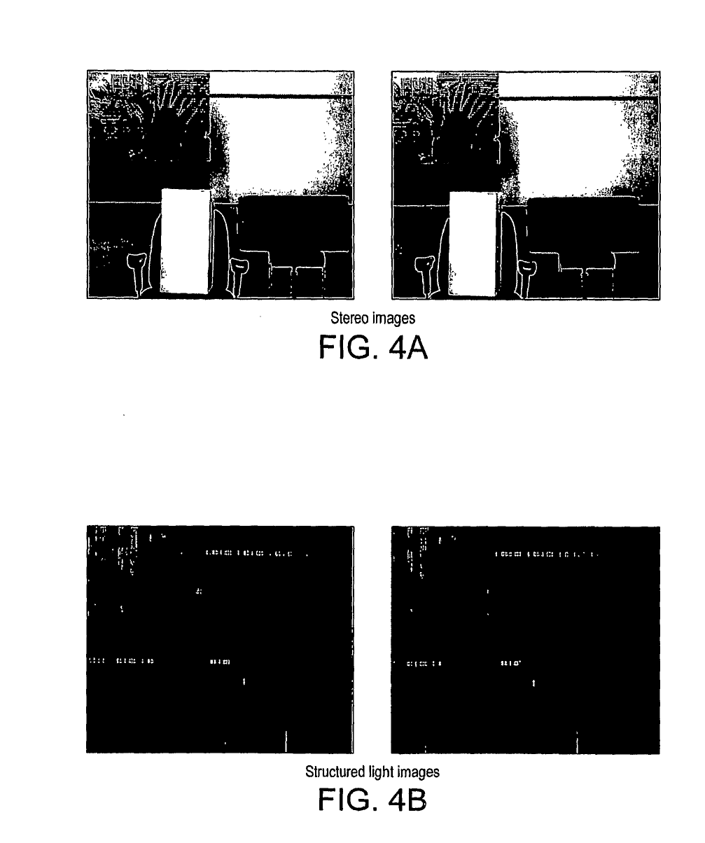

Images processed by the system and method of the present disclosure are illustrated in FIGS. 4A-B where FIG. 4A illustrates two input stereo images and FIG. 4B illustrates two input structured light images. In collecting the images, each method had different requirements. For example, structure light requires darker room settings as compared to stereo. Also different camera modes were used for each method. A single camera (e.g., a consumer grade digital camera) was used to capture the left and right stereo images by moving the camera in a slider, so that the camera conditions are identical for the left and right images. For structured light, a nightshot exposure was used, so that the color of the structured light has minimum distortion. For stereo matching, a regular automatic exposure was used since it's less sensitive to lighting environment settings. The structured lights were generated by a digital projector. Structured light images are taken in a dark room setting with all lights turned off except for the projector. Stereo images are taken with regular lighting conditions. During capture, the left-eye camera position was kept exactly the same for structured light and stereo matching (but the right-eye camera position can be varied), so the same reference image is used for aligning the structured light disparity map and stereo disparity map in combination.

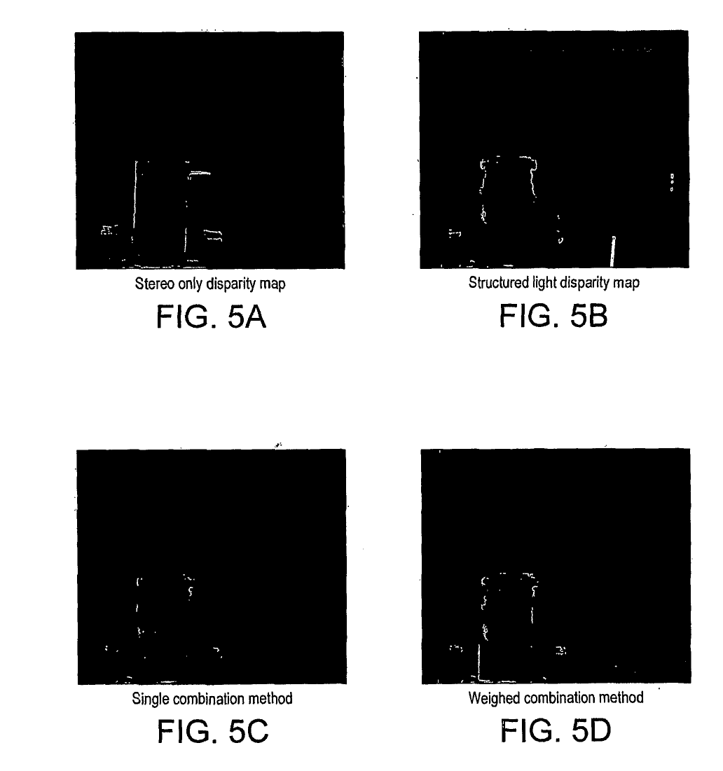

FIG. 5A is a disparity map generated from the stereo images shown in FIG. 4A and FIG. 5B is a disparity map generated from the structured light images shown in FIG. 4B. FIG. 5C is a disparity map resulting from the combination of the disparity maps shown in FIGS. 5A and 5B using a simple average combination method; and FIG. 5D is a disparity map resulting from the combination of the disparity maps shown in FIGS. 5A and 5B using a weighted average combination method. In FIG. 5A, it is observed that the stereo function did not provide good depth map estimation to the box on the right. On the other hand, structured light in FIG. 5B had difficulty identifying the black chair. Although the simple combination method provided some improvement in FIG. 5C, it did not capture the chair boundaries well. The weighted combination method provides the best depth map results with the main objects (i.e., chair, boxes) clearly identified, as shown in FIG. 5D.

Although the embodiments which incorporate the teachings of the present disclosure has been shown and described in detail herein, those skilled in the art can readily devise many other varied embodiments that still incorporate these teachings. Having described preferred embodiments for a system and method for three-dimensional (3D) acquisition and modeling of a scene (which are intended to be illustrative and not limiting), it is noted that modifications and variations can be made by persons skilled in the art in view of the above teachings. It is therefore to be understood that changes may be made in the particular embodiments of the present disclosure which are within the scope of the disclosure as set forth in the appended claims.

1. A three-dimensional acquisition method comprising:
acquiring at least two two-dimensional images of a scene;
applying a first depth acquisition function to the at least two two-dimensional images;
applying a second depth acquisition function to the at least two two-dimensional images;
combining an output of the first depth acquisition function with an output of the second depth acquisition function; and
generating a disparity map from the combined output of the first and second depth acquisition functions.

2. The method of claim 1, further comprising generating a depth map from the disparity map.

3. The method of claim 1, wherein the combining step includes registering the output of the first depth acquisition function to the output of the second depth acquisition function.

4. The method of claim 3, wherein the registering step includes adjusting the depth scales of the output of the first depth acquisition function and the output of the second depth acquisition function.

5. The method of claim 1, wherein the combining step includes averaging the output of the first depth acquisition function with the output of the second depth acquisition function.

6. The method of claim 1, furthering comprising:
applying a first weighted value to the output of the first depth acquisition function and a second weighted value to the output of the second depth acquisition function.

7. The method of claim 6, wherein the at least two two-dimensional images include a left eye view and a right eye view of a stereoscopic pair and the first weighted value is determined by an intensity of a pixel in the left eye image of a corresponding pixel pair between the left eye and right eye images.

8. The method of claim 1, further comprising reconstructing a three-dimensional model of the scene from the generated disparity map.

9. The method of claim 1, further comprising aligning the at least two two-dimensional images.

10. The method of claim 9, wherein the aligning step further includes matching a feature between the at least two two-dimensional images.

11. The method of claim 1, further comprising:
applying at least a third depth acquisition function to the at least two two-dimensional images;
applying at least a fourth depth acquisition function to the at least two two-dimensional images;
combining an output of the third depth acquisition function with an output of the fourth depth acquisition function;
generating a second disparity map from the combined output of the third and fourth depth acquisition functions; and
combining the generated disparity map from the combined output of the first and second depth acquisition functions with the second disparity map from the combined output of the third and fourth depth acquisition functions.

12. A system for three-dimensional information acquisition from two-dimensional images, the system comprising:
means for acquiring at least two two-dimensional images of a scene; and
a three-dimensional acquisition module configured for applying a first depth acquisition function to the at least two two-dimensional images, applying a second depth acquisition function to the at least two two-dimensional images and combining an output of the first depth acquisition function with an output of the second depth acquisition function.

13. The system of claim 12, further comprising a depth map generator configured for generating a depth map from the combined output of the first and second depth acquisition functions.

14. The system of claim 12, wherein the three-dimensional acquisition module is further configured for generating a disparity map from the combined output of first and second depth acquisition functions.

15. The system of claim 12, wherein the three-dimensional acquisition module is further configured for registering the output of the first depth acquisition function to the output of the second depth acquisition function.

16. The system of claim 15, further comprising a depth adjuster configured for adjusting the depth scales of the output of the first depth acquisition function and the output of the second depth acquisition function.

17. The system of claim 12, wherein the three-dimensional acquisition module is further configured for averaging the output of the first depth acquisition function with the output of the second depth acquisition function.

18. The system of claim 12, wherein the three-dimensional acquisition module is further configured for applying a first weighted value to the output of the first depth acquisition function and a second weighted value to the output of the second depth acquisition function.

19. The system of claim 18, wherein the at least two two-dimensional images include a left eye view and a right eye view of a stereoscopic pair and the first weighted value is determined by an intensity of a pixel in the left eye image of a corresponding pixel pair between the left eye and right eye images.

20. The system of claim 14, further comprising a three-dimensional reconstruction module configured for reconstructing a three-dimensional model of the scene from the generated depth map.

21. The system of claim 12, wherein the three-dimensional acquisition module is further configured for aligning the at least two two-dimensional images.

22. The system of claim 21, further comprising a feature point detector configured for matching a feature between the at least two two-dimensional images.

23. The system of claim 12, wherein the three-dimensional acquisition module is further configured for applying at least a third depth acquisition function to the at least two two-dimensional images, applying at least a fourth depth acquisition function to the at least two two-dimensional images; combining an output of the third depth acquisition function with an output of the fourth depth acquisition function and combining the combined output of the first and second depth acquisition functions with the combined output of the third and fourth depth acquisition functions.

24. A program storage device readable by a machine, tangibly embodying a program of instructions executable by the machine to perform method steps for acquiring three-dimensional information from two-dimensional images, the method comprising the steps of:
acquiring at least two two-dimensional images of a scene;
applying a first depth acquisition function to the at least two two-dimensional images;
applying a second depth acquisition function to the at least two two-dimensional images;
combining an output of the first depth acquisition function with an output of the second depth acquisition function; and
generating a disparity map from the combined output of the first and second depth acquisition functions.
